(19) United States
(12) Patent Application Publication
(10) Pub. No.: US 2012/0023241 A1
(43) Pub. Date: Jan. 26, 2012

(54) SSL Cache Session Selection

(75) Inventors: Anupam K. Goel, Pune (IN); Gang Lu, Acton, MA (US); Che-Liang Yang, Westford, MA (US)

(73) Assignee: Cisco Technology, Inc., San Jose, CA (US)

(21) Appl. No.: 12/843,351

(22) Filed: Jul. 26, 2010

(51) Int. Cl. G06F 15/16

(52) U.S. Cl. 709/228

(57) ABSTRACT

In one embodiment, a gateway implements: selecting, from a plurality of instances, an instance with which to begin a secure initial communication session; establishing, with the selected instance, a secure initial communication session; generating information regarding the session, the information including a session identifier associated with the session and an instance identifier associated with the selected instance; receiving a request to resume the session, the request including the session identifier and the instance identifier; using the instance identifier to identify a processing instance from the plurality of instances; and resuming the initial communication session using the identified processing instance, wherein at least a portion of the information associated with the initial communication session is re-used for the resumed session.

### FIELD OF THE DISCLOSURE

This disclosure relates to providing network access, and specifically for providing security gateways between trusted and un-trusted networks.

### BACKGROUND

In situations where a mobile node does not receive adequate service in the home or business, it may be advantageous for the mobile node user to be able to connect to a service provider's networks through a different network, such as a local broadband IP network. For example, a residential user may wish to use a home WLAN, such as a residential WiFi access point and associated broadband service to connect to services (such as internet access) that a cellular service vendor would otherwise provide. Some mobile phones support multiple connections by offering both cellular and a wireless local area network (WLAN) connectivity in a dual-mode phone. “Fixed-mobile convergence” is one of the names given to the idea to move toward seamless connectivity between fixed (e.g., wired) and wireless telecommunications networks, including connectivity to mobile voice, data, and IP-Multimedia Subsystem (IMS) services over such broadband IP access networks.

Several solutions have developed to help address fixed-mobile convergence. For example, when at home, a user of a dual-mode phone can connect through a WiFi Access Point (AP) to the same network that they would otherwise access through 3G or 4G technologies if they were away from home. The mobile phone maintains a WLAN connection through the AP, and also uses a wired broadband (such as DSL or cable) connection to access the mobile provider's network. A user could also connect to the operator's network through a femtocell. A femtocell is a 3G/4G cellular base station which can be thought of as a wireless AP.

### BRIEF DESCRIPTION OF THE DRAWINGS

FIG. 1 illustrates a communication network that includes a security gateway in accordance with certain embodiments involving WLAN applications.

FIG. 2 illustrates a communication network that includes a security gateway in accordance with certain embodiments involving femtocell applications.

FIG. 3 illustrates a security gateway in accordance with certain embodiments.

FIG. 4 illustrates a flow diagram for implementing a security gateway in accordance with certain embodiments.

FIG. 5 illustrates a flow diagram for implementing a security gateway in accordance with certain embodiments.

FIG. 6 illustrates a chassis implementing a security gateway in accordance with certain embodiments.

### OVERVIEW

In one embodiment, a method of communication comprises selecting, from a plurality of instances, a selected instance with which to begin a secure initial communication session; generating information associated with the initial communication session, where the information includes a session identifier associated with the initial communication session, and an instance identifier associated with the selected instance; receiving a request to resume the initial communication session, where the request includes the session identifier and the instance identifier; using the instance identifier to identify a processing instance from the plurality of instances; and resuming the initial communication session using the identified processing instance, such that by using the identified processing instance, at least a portion of the information associated with the initial communication session is re-used for the resumed session.

In certain embodiments, the instance identifier is sent to the server as part of a Transmission Control Protocol (TCP) connection process, such as a handshake. In certain of these embodiments, the request to resume the secure communication session includes a TCP segment, where the segment contains the instance identifier in an option field of the TCP message; the communication session includes a Secure Socket Layer (SSL) session, and the request to resume the secure communication session includes a SSL ClientHello message; and/or the communication session includes a Transport Layer Security (TLS) session, and the request to resume the secure communication session is a TLS ClientHello message.

In another embodiment, a method of communication comprises receiving, from a mobile node, a request to begin a communication session over a wireless network; sending, to a server, a request to begin a secure communication session; receiving, from the server, a session identifier and an instance identifier; storing the session identifier and the instance identifier; and sending, to the server, a request to resume the secure communication session, where the request to resume the secure communication session includes the session identifier and the instance identifier, and where the session identifier is associated with the secure communication session, and where the instance identifier is associated with a processing instance from among a plurality of processing instances on the server, and where the processing instance was used to establish the secure communication session.

In certain embodiments, the instance identifier is sent to the server as part of a Transmission Control Protocol (TCP) connection process, such as a handshake. In certain of these embodiments, the request to resume the secure communication session includes a TCP segment, where the segment contains the instance identifier in an option field of the TCP message; the communication session includes a Secure Socket Layer (SSL) session, and the request to resume the secure communication session includes a SSL ClientHello message; and/or the communication session is a Transport Layer Security (TLS) session, and the request to resume the secure communication session is a TLS ClientHello message.

In general, in yet another embodiment, a system comprising a memory capable of storing data; and a processor is configured to use the data such that the system can implement one or more of the embodiments described above.

In general, in yet another embodiment, logic is encoded in one or more tangible media that includes code for execution that when executed by a processor is operable to perform one or more of the embodiments described above.

### DESCRIPTION OF EXAMPLE EMBODIMENTS

Wireless communication systems and networks are used in connection with many applications, including, for example, satellite communications systems, portable digital assistants (PDAs), laptop computers, and cellular telephones. One significant benefit that users of such applications obtain is the ability to connect to a network (e.g., the Internet) as long as the user is within range of such a wireless communication system.

Current wireless communication systems use either, or a combination of, circuit switching and packet switching in order to provide mobile data services to a mobile node. A mobile node can be a cell phone, a PDA, a Blackberry, a laptop computer with a wireless card, or any other wireless device. The first generation of wireless telephone technology used analog mobile phones in which analog information signals were transmitted. As technology progressed a second generation (2G) of wireless service was introduced. In 2G systems, digital information signals were used to modulate a carrier. These 2G technologies used time division multiplexed access (TDMA) or code division multiple access (CDMA) technologies to distinguish multiple users. Such networks that were upgraded to handle higher-speed packet data in networks are referred to as 2.5G and 3G networks. The 3rd Generation Partnership Project (3GPP) and the 3rd Generation Partnership Project 2 (3GPP2) respectively developed the GSM/UMTS/HSDPA and cdmaOne/CDMA2000 technologies. The next evolution is 4G technology, which is referred to as long term evolution-system architecture evolution (LTE-SAE) and uses orthogonal frequency division multiple access (OFDMA) technology. Other wireless protocols have also developed including WiFi, an implementation of various IEEE 802.11 protocols, WiMAX, an implementation of IEEE 802.16, and HiperMAN, which is based on an ETSI alternative to IEEE 802.16.

As noted in the Background section above, solutions to help address fixed-mobile convergence include WiFi Access Points (APs) and femtocells. A femtocell connects to the service provider's network, for example, via broadband (such as DSL or cable) and allows service providers to extend service coverage indoors, especially where access would otherwise be limited or unavailable. The femtocell incorporates the functionality of a typical base station but extends it to allow a simpler, self contained deployment; an example is a UMTS femtocell containing a Home NodeB (HNB). Connected to an existing residential broadband service, an HNB provides 3G radio coverage for 3G handsets within a home. HNBs incorporate the capabilities of a standard Node B as well as the radio resource management functions of a standard Radio Network Controller RNC. In contrast to a WiFi Access Point, a femtocell could be a UMTS, CDMA/EVDO, LTE, or Mobile WiMAX Access Point, depending on the underlying mobile network technology. In a femtocell architecture, the bi-directional voice and data traffic is taken off the respective wireless network and instead placed on the broadband internet connection at the home or office.

Both of the above convergence scenarios can entail providing connectivity between a trusted, secure network (such as that owned by a wireless telephony provider), and an un-trusted network (such as a home WiFi network in conjunction with broadband DSL or cable networks). And for both scenarios, network security may be a consideration. One method of providing network security is through the use of cryptographic protocols that provide security for communications.

Transport Layer Security (“TLS”) (and its predecessor, Secure Sockets Layer, “SSL”) is a standard secure transport-layer cryptographic protocol built on top of the TCP protocol. TLS is an IETF standards track protocol, updated in RFC 5246, that was based on the earlier SSL specifications, including RFC 2246. Both RFC 2246 and RFC 5246 are incorporated by reference herein in their entirety as Exhibits 1 and 2. For purposes of this specification, SSL will be treated as synonymous with TLS unless otherwise indicated. SSL allows a client and server to reliably and securely send a stream of data in each direction. To create an SSL connection with a server, the SSL client will first establish a TCP connection with the server, beginning with the client sending a ClientHello message. The client then initiates exchanges of SSL handshaking messages with server through the TCP connection. When an SSL or TLS connection is established, the client and server negotiate a CipherSuite, exchanging CipherSuite codes in the ClientHello and ServerHello messages, which specifies a combination of cryptographic algorithms to be used for the connection. The key exchange and authentication algorithms are typically public key algorithms, or as in SSL-PSK, preshared keys may be used. The message authentication codes are made up from cryptographic hash functions using the Hash-based Message Authentication Code (HMAC) construction for SSL, and a non-standard pseudorandom function for SSL. The handshaking allows the client and server to authenticate each other and agree on a set of security algorithms with a “master secret”, which forms an SSL session identified by a unique ID known to both client and server. The master secret is used for deriving various keys to be used with the security algorithms to protect application data traffic for the current connection.

The public key operations (e.g., RSA) that are a part of implementing the SSL protocol may be relatively expensive in terms of computational power. SSL provides a secure shortcut in the handshake mechanism to avoid these operations—a “session caching and resumption” mechanism. In an ordinary full SSL handshake, the server sends a session id as part of the ServerHello message. The client associates this session id with the server's IP address and TCP port, so that when the client connects again to that server, it can use the session id to shortcut the handshake. In the server, the session id maps to the cryptographic parameters previously negotiated, specifically the “master secret.” Specifically, an SSL session (which includes a set of negotiated security algorithms and the master secret) can be cached within an SSL server when it is first created for a connection. When a new SSL connection is initiated, the client can propose in the ClientHello message to speed up the handshaking by using a cached session, specified by a session ID, at the server without negotiating a new session. If the server can find the specified cached session, the client and server can go directly to use the cached session information to protect application data traffic for this new connection. This is referred to as TLS and/or SSL session resumption. Sessions may be resumed after events such as the interruption or disconnection of a previous session.

In certain embodiments, a gateway is enabled to efficiently support Transport Layer Security (“TLS”) (and/or Secure Socket Layer—“SSL”) session caching and resumption features. The gateway includes a plurality of SSL server processes, each of which can cache information associated with SSL sessions that have been previously established. A SSL server that is responsible for caching a new session embeds its own tag (such as an instance identifier of that SSL server) as part of the SSL session ID when a new SSL session (and ID) is created. The SSL session ID is returned to the client. Subsequently, when an SSL client proposes to resume a previous SSL session for a new SSL connection, the SSL client passes the instance identifier/tag associated with the previous session back to the gateway as a TCP option in a TCP message associated with the SSL resumption message.

The TCP option may be sent in one or more of the TCP segments that are sent to the security gateway as part of the handshaking used to establish the TCP connection with the gateway, which in some embodiments may be considered part of the overall resumption request process. This TCP connection is then used to send the SSL resumption request from the client to the gateway. When performing SSL session resumption, the gateway can then use the tag to identify which server or servers contain the previously cached information. Using this method, there is no need to use a distributed database, and expensive lookup operations may be reduced or avoided.

### WLAN Applications

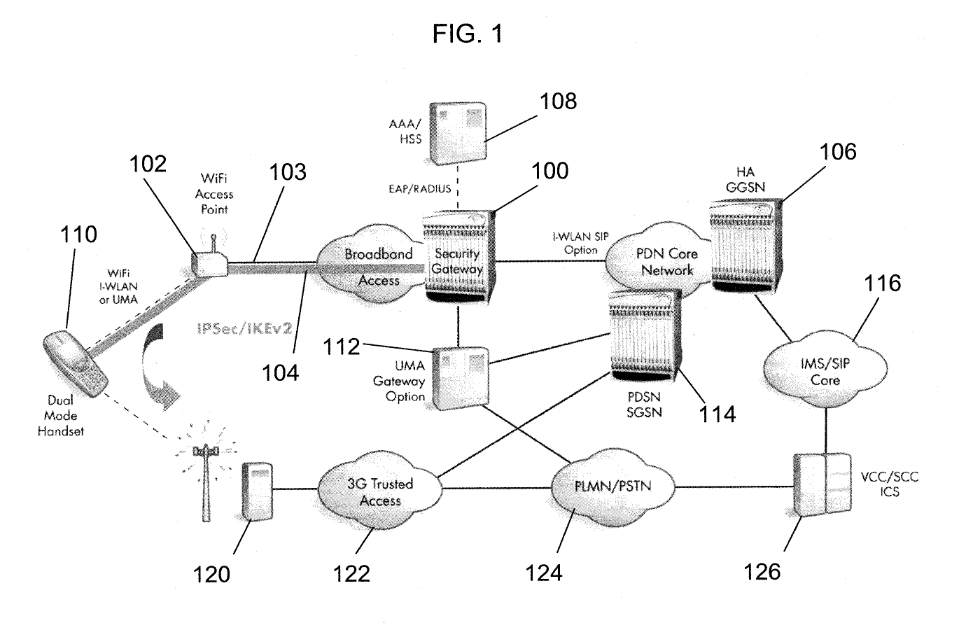

As shown in FIG. 1, a mobile node 110 communicates with a WiFi access point 102 using WiFi internetworking WLAN (I-WLAN) or Unlicensed Mobile Access (UMA) specifications. Access point 102 communicates with security gateway 100, for example, via broadband or other access network 103.

The security gateway 100 encapsulates and de-encapsulates subscriber-initiated IP Security (IPSec)/IKEv2 tunnels 104. The security gateway also performs authentication and authorization of the subscriber equipment, IP address assignment, the foreign agent function for Mobile IP aware devices, and provides subscriber usage accounting records. The IPSec/IKIEv2 tunnels are used to perform secure transfers of authentication information and subscriber data over the un-trusted interfaces and backhauls.

When a subscriber requests WLAN access, the security gateway 100 terminates the mobile node-initiated or access point-initiated IPSec/IKEv2 tunnel 104, which carries both authentication information and subscriber data. The security gateway 100 employs additional security features to provide increase WLAN security, including Stateful Firewall and NAT Traversal to extend subscriber access when NAT WLAN access points are employed. After terminating the secure tunnel from the subscriber, the security gateway communicates with an authentication, authorization, and accounting (AAA) server and/or home subscriber server (HSS) 108 in order to authenticate and authorize the subscriber. Extensible authentication protocol (EAP), RADIUS and/or DIAMETER processing may be used for this purpose. Furthermore, the security gateway function can be connected to or integrated with other packet core functions, such as a PDSN/SGSN 114 (packet data serving node/serving GPRS support node), Gateway General packet radio service Serving Node GGSN 106, or with the a proxy-call session control function P-CSCF function, such as session control manager (SCM) solution. Security gateway 100 may also interoperate with a UMA gateway 112, which in turn may provide access to a Public Land Mobile Network (PLMN) or Public Switched Telephone Network (PSTN) 124. Alternatively, mobile node 110 may connect to these networks through a controller 120 via 3G Trusted Access 122 when the mobile note is not using an un-trusted network through access point 102. Services may be provided to the mobile node 110 through Voice Call Continuity (VCC), Service Centralization and Continuity (SCC), and/or IMS Centralized services (ICS) 126, in conjunction with IMS/SIP Core 116.

Security gateway 100 operates as an edge gateway and can provide 3GPP2 Interworking Packet Data Interworking Function (PDIF), 3GPP Packet Data Gateway PDG, and/or Tunnel Terminating Gateway (TTG) functionality, in order to supply WLAN access for subscribers. Using TTG, the gateway 100 connects to the mobile operator's GGSN 106 to provide mobile operator services, and in the PDG mode, the gateway connects to IMS or external IP networks such as IMS/SIP Core 116 to provide enhanced services. WLAN applications may include I-WLAN Fixed Mobile Convergence (FMC) services to dual mode handsets and/or laptops, WLAN data services to devices such as data cards, Unlicensed Mobile Access (UMA) applications, and WLAN based Mobile voice-over-IP (VoIP) services.

### Femtocell Applications

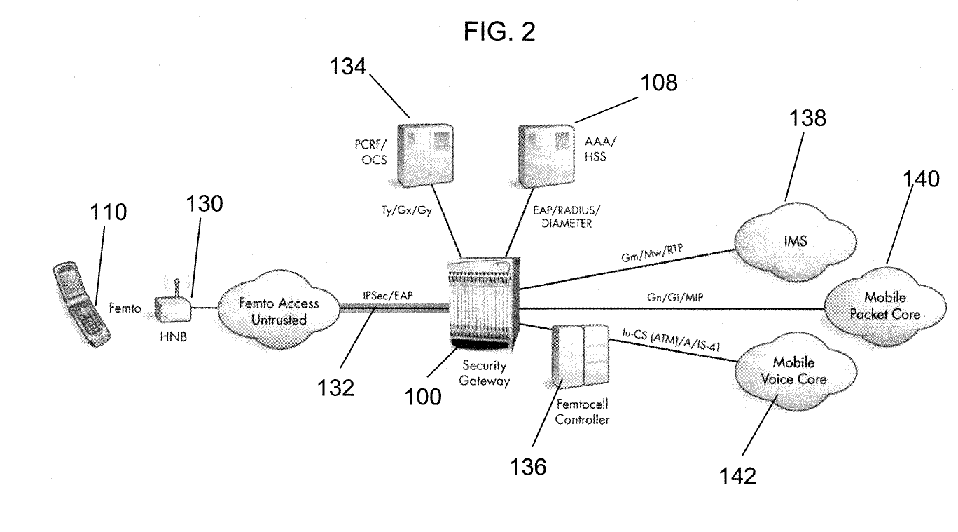

As shown in FIG. 2, security gateway 100 provides the security function for femtocell or Home NodeB (HNB) aggregation to enable intelligent femtocell services. When used in femtocell or 3GPP-defined HNB applications, the security gateway 100 function provides a functional portion of the Femtocell/HNB Gateway in UMTS, CDMA and WiMAX networks, both in legacy circuit based architectures and SIP/IMS based architectures.

For femtocell access, security gateway 100 terminates the mobile node-initiated or femtocell-initiated IPSec/IKEv2 tunnel 132, which carries both authentication information and subscriber data, and may use Extensible Authentication Protocol (EAP). After terminating the secure tunnel 132 from the subscriber, the security gateway 100 communicates with the existing external AAA server, such as a RADIUS or DIAMETER server 108, in order to authenticate and authorize the femtocell and subscriber. The security gateway 100 may also interoperate with a policy and charging rules function (PCRF) and/or online charging system (OCS) 134 through Tx, Gx, and/or Gy interfaces. In addition, security gateway 100 may provide controlled access to a femtocell controller 136, IMS services 138, a mobile packet core network 140, and/or a mobile voice core network 142.

### Global Session Cache Database

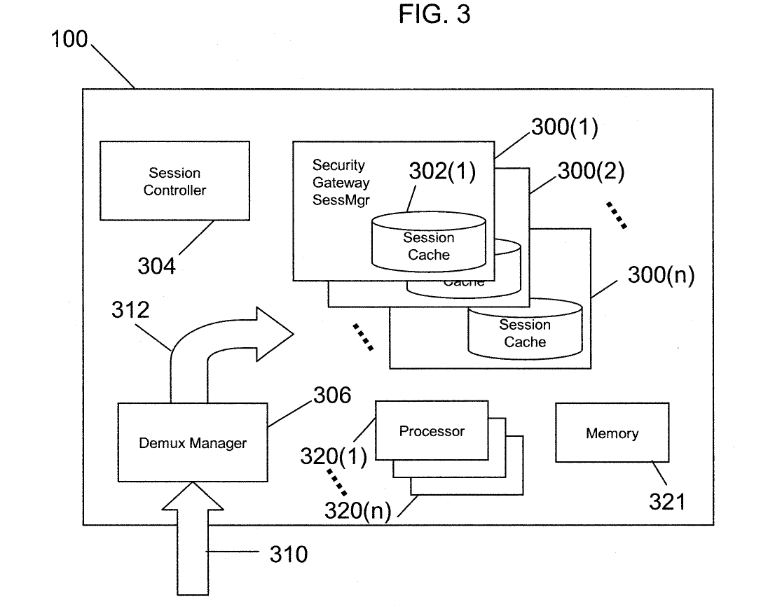

FIG. 3 illustrates a security gateway. Security gateway 100 is built on a distributed computing platform that may be implemented in a single chassis. Gateway 100 also contains one or more processors 320(1) through 320(n), and memory 321, each of which may collocated or be distributed on different cards. The security gateway 100 contains <n> SSL server processes 300(1), 300(2), through 300(n), where the processes may be running on multiple cards. Each SSL server process is called a “sessmgr.”

Other logical functions included in the security gateway include a session controller 304 and a demux-manager 306. Session controller 304 can be a software task, which is responsible for managing sessmgr instances. Each sessmgr has its own session identifier, which is unique within the security gateway. Session controller 304 can create and manage sessmgr instances to handle subscriber session tasks.

Sessmgr instances 300(1) to 300(n) receive traffic flows from demux-manager 306, which is configured by session controller 304, and acts as a front-end for the gateway. Demux-manager 306 can be an internal router of data flows, and may be implemented in software or hardware or combination thereof. Demux-manager 306 looks at incoming traffic 310 and decides where the data should go within the gateway for processing. Demux-manager is the signaling demultiplexing task in the chassis. There can be a demux-manager task running for each service type, for example for SSL services versus GGSN services. One purpose of this software task is to handle and direct incoming new and resumed SSL subscriber sessions, and to assign the session to a sessmgr instance. Another purpose is to generally direct incoming traffic internally. For each session, directed traffic 312 is sent to a sessmgr instance to which the traffic is assigned. The demux-manager 306 can also be used for load balancing within a security gateway.

### SSL Cache Session Selection Based on a Global Session Cache Database

To enable SSL/TLS session resumption in this distributed environment, the gateway can maintain a global session cache database to be shared by all distributed sessmgrs. When a new SSL session is created by a sessmgr, it can be saved in the database. A front-end process such as the demux manager 306 of gateway 100 can route an incoming ClientHello message to any sessmgr because each sessmgr can look up the cached session from the common database.

In embodiments that do not use a shared global database for SSL session cache, the front-end process can route an incoming ClientHello message to a specific sessmgr process which had previously locally cached the session information corresponding to the SessionID proposed in the ClientHello message. One such embodiment routes SSL/TLS messages based on an instance identifier in a TCP option sent by the client.

### SSL Cache Session Selection Based on TCP Option

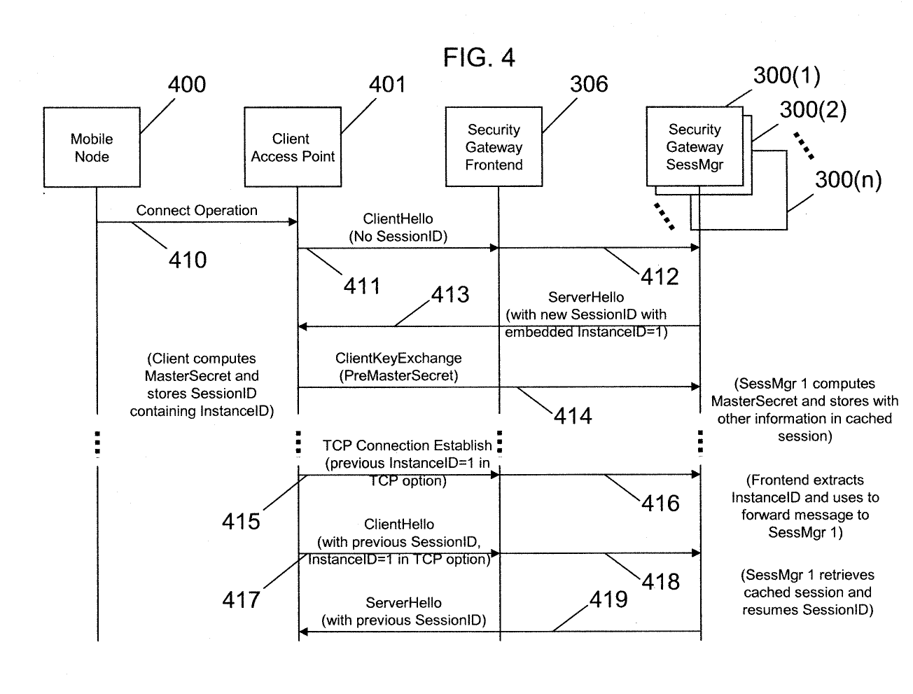

FIG. 4 illustrates a security gateway receiving an initial SSL connection request, establishing an SSL session, and subsequently processing an incoming ClientHello message requesting resumption of the same session. In this embodiment, the client resumes the SSL session by sending the security gateway the instance identifier of the sessmgr that was used to negotiate the original session. First, mobile node 400 optionally initiates a secure connection with a security gateway, including connection operation 410. This may be accomplished by mobile node 400 setting up a secure connection with the security gateway directly, or by using an access point 401. Access point 401 may be, for example, a WLAN AP or a femtocell HNB, where the access point 401 sets up the secure connection with the security gateway on behalf of the mobile node 400. Alternatively, the mobile node may already be connected to the access point before the request to resume the SSL session.

Subsequently, client access point 401 sends an SSL ClientHello message 411 to the security gateway, where a security gateway front end process 306 receives the message. No session identifier is sent with message 411, indicating that the client access point is not attempting to resume a previously-established communication session. Not explicitly shown in FIG. 4 are the client's TCP handshaking operations to establish the TCP connection prior to sending the initial ClientHello message. For clarity, details of these and various other signaling between the mobile node 400, access point 401 and the security gateway are also omitted from FIG. 4.

Continuing with the description of the establishment of the initial SSL session, front end demux-manager 306 then forwards a ClientHello message 412 to one of a plurality of security gateway sessmgr processes. In this example, the ClientHello is sent to an instance with an instance identifier/tag of “1”—e.g., sessmgr 300(1). Generally, the gateway distributes incoming initial SSL session establishment requests using any one or a combination of distribution schemes, and other sessmgr processes—e.g., sessmgr 300(2) through 300(n)—may be selected to process SSL session requests at other times. Distribution schemes include round-robin, random selection, and hash-based methods; the selection of an appropriate sessmgr may depend on (1) which sessmgr processes are available; (2) a function of the data associated with the ClientHello message and/or; (3) other considerations. Sessmgr selection may be accomplished using the gateway's session controller or other functions.

Once a sessmgr is selected and receives the ClientHello message 412, that sessmgr is responsible for establishing the requested SSL communication session. This may include additional messaging with the client AP, as well as the computation of a master secret and/or other information such as key data for the session, the key data being derived from the master secret. The exact process for setting up the session and the associated data may vary depending at least on the cipher suite that is mutually selected during the setup of the SSL session.

At some point during the setup sequence, sessmgr 300(1) returns a ServerHello message 413 to the AP 401. The ServerHello message includes a session identifier called the SessionID. The SessionID contains multiple bytes, and an instance identifier is embedded in some portion of the SessionID. In one implementation, the SSL SessionID can be 8 bytes, where the first byte is the instance identifier. After receiving the SessionID with the embedded instance identifier, AP 401 stores the session identifier for later use, and also optionally extracts and stores the embedded instance identifier. Later, and possibly after a ClientKeyExchange message 414 is sent by AP 401 to the sessmgr in charge of establishing the new session, sessmgr 300(1) computes and stores information associated with the session. In some embodiments, the sessmgr stores the resulting session information locally to the sessmgr process.

Subsequently, possibly after a period of non-use and termination of the TCP connection associated with the SSL session, the client access point 401 attempts to resume the previously-established session. As part of this, access point 401 sends a ClientHello message 415 containing the previously-used SessionID to identify the session to be resumed. If this request is received by the same sessmgr that handled the setup of the session when it was originally established, efficiencies may be realized if that sessmgr has retained the session (and associated information) and is thus able to avoid re-computing some or all of the data associated with the session. To enable this, access point 401 sends to the gateway the instance identifier it originally received during the initial session creation. By receiving the instance identifier, the gateway can efficiently locate the previously-used sessmgr without having to, for example, use a lookup table to find it.

Prior to sending a ClientHello message to request SSL resumption, access point 401 will send at least one message 415 to establish a TCP session with the security gateway 100. As part of this TCP connection establishment, access point 401 sends the previously-received instance identifier back to the security gateway within a TCP option, such as an option field of the header of a TCP segment used in access point 410's connection handshaking 415. The TCP option that is used may be an already-established option, or a new option used specifically for this purpose.

The TCP option may look like:

The ‘kind’ field may be one octet in length whose value may include a number assigned by the Internet Assigned Numbers Authority (IRNA). The ‘Len’ field may also be one octet, and specifies the length of the TCP option. In one embodiment this length is 6. The ‘VALUE’ field can be 4 octets, and can carry the SSL session ID.

The front end 306 will generally accept a TCP connection before accepting the SSL/TLS ClientHello, so the front end 306 can use the TCP option to efficiently direct the TCP connection request 416 (and subsequent SSL/TLS messages) to the correct sessmgr even before the ClientHello message is received. The instance identifier may also be contained in any part of a TCP handshaking process or other information exchange before the SSL connection is resumed. The front end 306 can extract the instance identifier (or some other indication of which instance processed the identified session earlier), and use it to determine which of the plurality of running sessmgr instances should handle the SSL session resumption request. Nominally, the selected instance will still have the session information retained locally (such as the master secret and associated key data) that was previously computed by the same instance. Thus, the session may be resumed without having to recomputed some or any of the originally-computed information. If the identified (preferred) session is not available, front end 306 can direct the TCP connection (and subsequent SSL messaging) to a different sessmgr.

After the TCP connection is established and a sessmgr selected, access point 401 sends a ClientHello message 417 containing the original SessionID which indicates the client's desire to resume the SSL session instead of creating a new session. Front end 306 then forwards the ClientHello message 418 to the sessmgr that was previously selected using the instance identifier.

If the selected sessmgr instance is able to resume the session, it will send a ServerHello message 419 back to AP 401. The ServerHello will include the same SessionID that was sent as part of the ClientHello message used by the AP 401 to request session resumption. This signifies to AP 401 that the session may be successfully resumed. Otherwise, the ServerHello message will contain a new, different, SessionID than the one sent in the ClientHello message.

As an alternative to sending the instance identifier as a TCP option in the TCP connection handshaking, the access point 401 could also send a ClientHello message 414 within a TCP segment after establishing the TCP connection, where the TCP segment containing the ClientHello also contains the instance identifier in an option field of the TCP header. In yet another alternative embodiment, instead of utilizing an instance identifier in a TCP option, the security gateway can use the instance identifier embedded in the SessionID by extracting it from the ClientHello message (either by the front end or some other process) within the TCP packet(s) containing the ClientHello. The security gateway can then use the extracted instance identifier in the same manner as an instance identifier from the TCP header option.

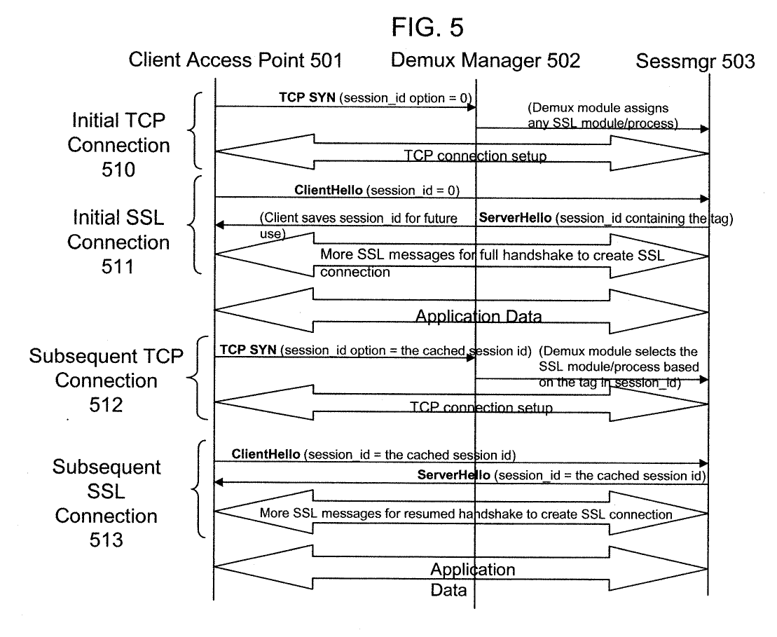

FIG. 5 illustrates another view of an embodiment, including receiving an initial SSL connection request, establishing an SSL session, and subsequently processing an incoming ClientHello message requesting resumption of the same session. FIG. 5 illustrates the initial TCP connection 510, initial SSL connection 511, subsequent TCP connection 512 and subsequent SSL connection 513, as well as the associated messaging flow between client access point 501, demux-manager 502 and a sessmgr 503. There may be multiple instances of sessmgr 503.

Physical implementation

The security gateway described above is implemented in a chassis in some embodiments. This chassis can implement multiple and different integrated functionalities. In some embodiments, a security gateway (SeGW), an access gateway, a packet data serving node (PDSN), a foreign agent (FA), and/or home agent (HA) can be implemented on a chassis. Other types of functionalities that can also be implemented on a chassis in other embodiments are a Gateway General packet radio service Serving Node (GGSN), a serving GPRS support node (SGSN), a packet data inter-working function (PDIF), an access service network gateway (ASNGW), a base station, an access network, a User Plane Entity (UPE), an IP Gateway, an access gateway, a session initiation protocol (SIP) server, a proxy-call session control function (P-CSCF), and an interrogating-call session control function (I-CSCF), a serving gateway (SGW), and a packet data network gateway (PDN GW). In certain embodiments, one or more of the above-mentioned other types of functionalities are integrated together or provided by the same functionality. For example, an access network can be integrated with a PDSN. A chassis can include a PDSN, a FA, a HA, a GGSN, a PDIF, an ASNGW, a UPE, an IP Gateway, an access gateway, or any other applicable access interface device. In certain embodiments, a chassis is provided by Starent Networks, Corporation of Tewksbury, Mass. in a ST40 multimedia platform.

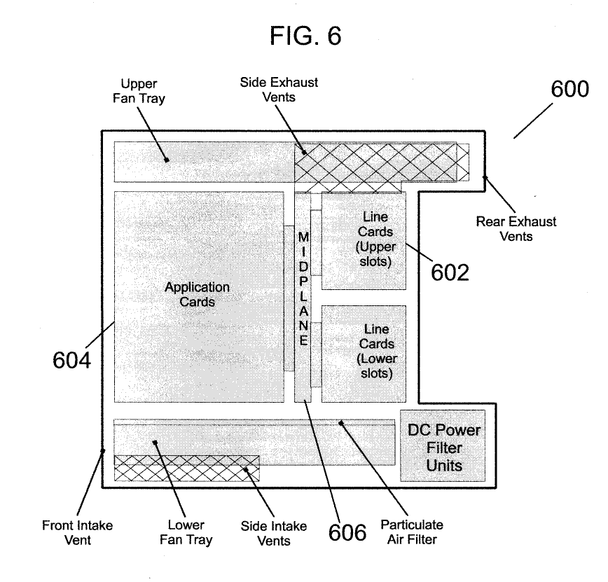

The features of a chassis that implements a gateway, in accordance with some embodiments, are further described below. FIG. 6 illustrates positioning of cards in the chassis in accordance with some embodiments. The chassis 600 includes slots for loading application cards 604 and line cards 602. A midplane 606 can be used in the chassis to provide intra-chassis communications, power connections, and transport paths between the various installed cards. The midplane 606 can include buses such as a switch fabric, a control bus, a system management bus, a redundancy bus, and a time division multiplex (TDM) bus. The switch fabric is an IP-based transport path for user data throughout the chassis implemented by establishing inter-card communications between application cards and line cards. The control bus interconnects the control and management processors within the chassis. The chassis management bus provides management of system functions such as supplying power, monitoring temperatures, board status, data path errors, card resets, and other failover features. The redundancy bus provides transportation of user data and redundancy links in the event of hardware failures. The TDM bus provides support for voice services on the system.

The chassis supports at least four types of application cards: a switch processor card, a system management card, a packet service card, and a packet accelerator card. The switch processor card serves as a controller of the chassis and is responsible for such things as initializing the chassis and loading software configurations onto other cards in the chassis. The packet accelerator card provides packet processing and forwarding capabilities. Each packet accelerator card is capable of supporting multiple contexts. Hardware engines can be deployed with the card to support parallel distributed processing for compression, classification traffic scheduling, forwarding, packet filtering, and statistics compilations. The system management card is a system control and management card for managing and controlling other cards in the gateway device. The packet services card is a high-speed processing card that provides multi-threaded point-to-point, packet data processing, and context processing capabilities, among other things.

The packet accelerator card performs packet-processing operations through the use of control processors and a network processing unit. The network processing unit determines packet processing requirements; receives and transmits user data frames to/from various physical interfaces; makes IP forwarding decisions; implements packet filtering, flow insertion, deletion, and modification; performs traffic management and traffic engineering; modifies/adds/strips packet headers; and manages line card ports and internal packet transportation. The control processors, also located on the packet accelerator card, provide packet-based user service processing. The line cards when loaded in the chassis provide input/output connectivity and can also provide redundancy connections as well.

The operating system software can be based on a Linux software kernel and run specific applications in the chassis such as monitoring tasks and providing protocol stacks. The software allows chassis resources to be allocated separately for control and data paths. For example, certain packet accelerator cards can be dedicated to performing routing or security control functions, while other packet accelerator cards are dedicated to processing user session traffic. As network requirements change, hardware resources can be dynamically deployed to meet the requirements in some embodiments. The system can be virtualized to support multiple logical instances of services, such as technology functions (e.g., a SeGW PDN GW, SGW, PDSN, ASNGW, PDIF, HA, GGSN, or IPSG).

The chassis' software can be divided into a series of tasks that perform specific functions. These tasks communicate with each other as needed to share control and data information throughout the chassis. A task is a software process that performs a specific function related to system control or session processing. Three types of tasks operate within the chassis in some embodiments: critical tasks, controller tasks, and manager tasks. The critical tasks control functions that relate to the chassis' ability to process calls such as chassis initialization, error detection, and recovery tasks. The controller tasks mask the distributed nature of the software from the user and perform tasks such as monitor the state of subordinate manager(s), provide for intra-manager communication within the same subsystem, and enable inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem can include critical tasks, controller tasks, and manager tasks. Some of the subsystems that can run on a chassis include a system initiation task subsystem, a high availability task subsystem, a recovery control task subsystem, a shared configuration task subsystem, a resource management subsystem, a virtual private network subsystem, a network processing unit subsystem, a card/slot/port subsystem, and a session subsystem.

The system initiation task subsystem is responsible for starting a set of initial tasks at system startup and providing individual tasks as needed. The high availability task subsystem works in conjunction with the recovery control task subsystem to maintain the operational state of the chassis by monitoring the various software and hardware components of the chassis. Recovery control task subsystem is responsible for executing a recovery action for failures that occur in the chassis and receives recovery actions from the high availability task subsystem. Shared configuration task subsystem provides the chassis with an ability to set, retrieve, and receive notification of chassis configuration parameter changes and is responsible for storing configuration data for the applications running within the chassis. Resource management subsystem is responsible for assigning resources (e.g., processor and memory capabilities) to tasks and for monitoring the task's use of the resources.

Virtual private network (VPN) subsystem manages the administrative and operational aspects of VPN-related entities in the chassis, which include creating separate VPN contexts, starting IP services within a VPN context, managing IP pools and subscriber IP addresses, and distributing the IP flow information within a VPN context. In some embodiments, within the chassis, IP operations are done within specific VPN contexts. The network processing unit subsystem is responsible for many of the functions listed above for the network processing unit. The card/slot/port subsystem is responsible for coordinating the events that occur relating to card activity such as discovery and configuration of ports on newly inserted cards and determining how line cards map to application cards. The session subsystem is responsible for processing and monitoring a mobile subscriber's data flows in some embodiments. Session processing tasks for mobile data communications include: A10/A11 termination for CDMA networks, GSM tunneling protocol termination for GPRS and/or UMTS networks, asynchronous PPP processing, packet filtering, packet scheduling, Diffsery codepoint marking, statistics gathering, IP forwarding, and AAA services, for example. Responsibility for each of these items can be distributed across subordinate tasks (called managers) to provide for more efficient processing and greater redundancy. A separate session controller task serves as an integrated control node to regulate and monitor the managers and to communicate with the other active subsystem. The session subsystem also manages specialized user data processing such as payload transformation, filtering, statistics collection, policing, and scheduling.

In some embodiments, the software needed for implementing a process or a database includes a high level procedural or an object-orientated language such as C, C++, C#, Java, or Perl. The software may also be implemented in assembly language if desired. Packet processing implemented in a chassis can include any processing determined by the context. For example, packet processing may involve high-level data link control (HDLC) framing, header compression, and/or encryption. In certain embodiments, the software is stored on a storage medium or device such as read-only memory (ROM), programmable-read-only memory (PROM), electrically erasable programmable-read-only memory (EEPROM), flash memory, or a magnetic disk that is readable by a general or special purpose-processing unit to perform the processes described in this document.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow.

What is claimed is:

1. A method comprising:
selecting, from a plurality of instances, a selected instance with which to begin a secure initial communication session;
generating information associated with the initial communication session, wherein the information includes a session identifier associated with the initial communication session, and an instance identifier associated with the selected instance;
receiving a request to resume the initial communication session, wherein the request includes the session identifier and the instance identifier;
using the instance identifier to identify a processing instance from the plurality of instances; and
resuming the initial communication session using the identified processing instance, wherein by using the identified processing instance, at least a portion of the information associated with the initial communication session is re-used for the resumed session.

2. The method of claim 1, wherein the instance identifier is received as part of a Transmission Control Protocol (TCP) connection process.

3. The method of claim 2, wherein the request to resume the secure communication session includes a TCP segment, wherein the segment contains the instance identifier in an option field of the TCP message.

4. The method of claim 2, wherein the communication session is one of a Secure Socket Layer (SSL) session and a Transport Layer Security (TLS) session, and the request to resume the secure communication session includes one of a SSL ClientHello message and TLS ClientHello message.

5. A method comprising:
sending, to a server, a request to begin a secure communication session;
receiving, from the server, a session identifier and an instance identifier;
storing the session identifier and the instance identifier; and
sending, to the server, a request to resume the secure communication session, wherein the request to resume the secure communication session includes the session identifier and the instance identifier, and wherein the session identifier is associated with the secure communication session, and wherein the instance identifier is associated with a processing instance from among a plurality of processing instances on the server, and wherein the processing instance was used to establish the secure communication session.

6. The method of claim 5, wherein the instance identifier is sent to the server as part of a Transmission Control Protocol (TCP) connection process.

7. The method of claim 6, wherein the request to resume the secure communication session includes a TCP segment, wherein the segment contains the instance identifier in an option field of the TCP message.

8. The method of claim 6, wherein the communication session is one of a Secure Socket Layer (SSL) session and a Transport Layer Security (TLS) session, and the request to resume the secure communication session includes one of a SSL ClientHello message and TLS ClientHello message.

9. A system comprising:
a memory capable of storing data; and
a processor configured for using the data such that the system can:
select, from a plurality of instances, a selected instance with which to begin a secure initial communication session;
generate information associated with the initial communication session, wherein the information includes a session identifier associated with the initial communication session, and an instance identifier associated with the selected instance;
receive a request to resume the initial communication session, wherein the request includes the session identifier and the instance identifier;
use the instance identifier to identify a processing instance from the plurality of instances; and
resume the initial communication session using the identified processing instance, wherein by using the identified processing instance, at least a portion of the information associated with the initial communication session is re-used for the resumed session.

10. The system of claim 9, wherein the instance identifier is received as part of a Transmission Control Protocol (TCP) connection process.

11. The system of claim 10, wherein the request to resume the secure communication session includes a TCP segment, wherein the segment contains the instance identifier in an option field of the TCP message.

12. The system of claim 10, wherein the communication session is one of a Secure Socket Layer (SSL) session and a Transport Layer Security (TLS) session, and the request to resume the secure communication session includes one of a SSL ClientHello message and TLS ClientHello message.

13. A system comprising:
a memory capable of storing data; and
a processor configured for using the data such that the system can:
send, to a server, a request to begin a secure communication session;
receive, from the server, a session identifier and an instance identifier;
store the session identifier and the instance identifier; and
send, to the server, a request to resume the secure communication session, wherein the request to resume the secure communication session includes the session identifier and the instance identifier, and wherein the session identifier is associated with the secure communication session, and wherein the instance identifier is associated with a processing instance from among a plurality of processing instances on the server, and wherein the processing instance was used to establish the secure communication session.

14. The system of claim 13, wherein the instance identifier is sent to the server as part of a Transmission Control Protocol (TCP) connection process.

15. The system of claim 14, wherein the request to resume the secure communication session includes a TCP segment, wherein the segment contains the instance identifier in an option field of the TCP message.

16. The system of claim 14, wherein the communication session is one of a Secure Socket Layer (SSL) session and a Transport Layer Security (TLS) session, and the request to resume the secure communication session includes one of a SSL ClientHello message and TLS ClientHello message.

17. Logic encoded in one or more tangible media that includes code for execution and when executed by a processor is operable to perform operations comprising:
selecting, from a plurality of instances, a selected instance with which to begin a secure initial communication session;
generating information associated with the initial communication session, wherein the information includes a session identifier associated with the initial communication session, and an instance identifier associated with the selected instance;
receiving a request to resume the initial communication session, wherein the request includes the session identifier and the instance identifier;
using the instance identifier to identify a processing instance from the plurality of instances; and
resuming the initial communication session using the identified processing instance, wherein by using the identified processing instance, at least a portion of the information associated with the initial communication session is re-used for the resumed session.

18. The logic of claim 17, wherein the instance identifier is received as part of a Transmission Control Protocol (TCP) connection process.

19. The logic of claim 18, wherein the request to resume the secure communication session includes a TCP segment, wherein the segment contains the instance identifier in an option field of the TCP message.

20. The logic of claim 18, wherein the communication session is one of a Secure Socket Layer (SSL) session and a Transport Layer Security (TLS) session, and the request to resume the secure communication session includes one of a SSL ClientHello message and TLS ClientHello message.
